(19) United States
(12) Patent Application Publication
(10) Pub. No.: US 2012/0285340 A1
(43) Pub. Date: Nov. 15, 2012

(54) PRINTER

(75) Inventor: PIAO-CHENG HSU, Tu-Cheng (TW)

(73) Assignee: HON HAI PRECISION INDUSTRY CO., LTD., Tu-Cheng (TW)

(21) Appl. No.: 13/163,754

(22) Filed: Jun. 20, 2011

(30) Foreign Application Priority Data
May 13, 2011 (TW) 100116759

(51) Int. Cl. B41F 5/02

(52) U.S. Cl. 101/216

(57) ABSTRACT

A printer having an ink drying apparatus is provided. The printer includes a support substrate comprising two parts; a print assembly; a feed roller assembly to feed print media towards the print assembly along the support substrate; a heater substrate; and a silicone rubber heater, in form of thin sheet and attached tightly to a bottom surface of the heat substrate for transferring heat to the print media. The two parts of the support substrate are respectively installed on two sides of the heat substrate and below the print assembly, for supporting the print media. The heat substrate and the silicone rubber heater are set below the print assembly.

### CROSS-REFERENCE TO RELATED APPLICATIONS

Related subject matter is disclosed in a copending application entitled, “PRINTER”, filed on **** (Application No. *****, Atty. Docket No. U.S. 38880), and assigned to the same assignee as named herein.

### BACKGROUND

1. Technical Field

The present disclosure relates to printers, and more particularly, to a printer having an ink drying apparatus which can effectively dry ink on a print media thereof.

2. Description of Related Art

FIG. 1 is a sectional view schematically showing a conventional printer. In FIG. 1, a conventional printer 100 includes a heater 10, a heat substrate 20, a print assembly 30, a feed roller assembly 40, and a print media 50. The heater 10 may be a halogen lamp. The print media 50 may be a paper. The heat substrate 20 is set above the heater 10, for transmitting heat generated by the heater 100 to the print media 50.

The print assembly 30 includes a print head, for spraying ink on the print media 50 to form an image. The feed roller assembly 40 feeds the print media 50 towards the print assembly 30 along the heat substrate 20. The print media 50 is dried after the ink is sprayed and output after being printed, thereby the print media 50 is prevented from being wet and distorted.

However, employing the heat substrate 20 to dry the print media 50 leads to high heat loss, increases overall size of the printer, and the print media 50 cannot absorb heat uniformly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a sectional view schematically showing a conventional printer.

FIG. 2 is a sectional view schematically showing a printer employing an ink drying apparatus according to a first embodiment of the present disclosure.

FIG. 3 is a sectional view schematically showing a printer employing an ink drying apparatus according to a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

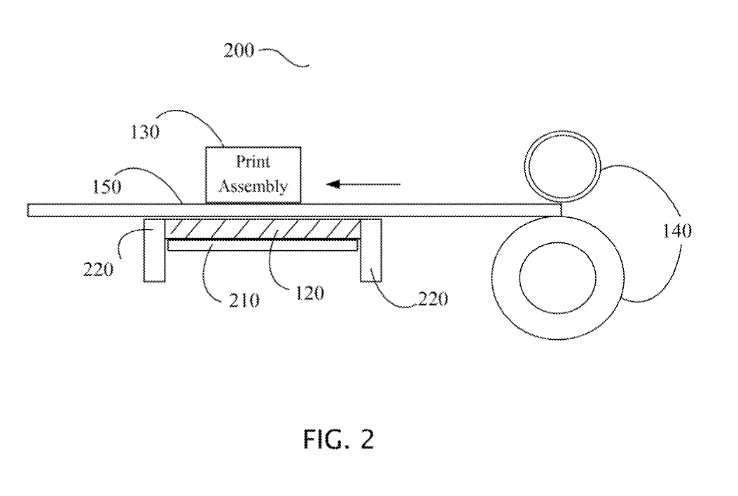

FIG. 2 is a sectional view schematically showing a printer employing an ink drying apparatus according to a first embodiment of the present disclosure.

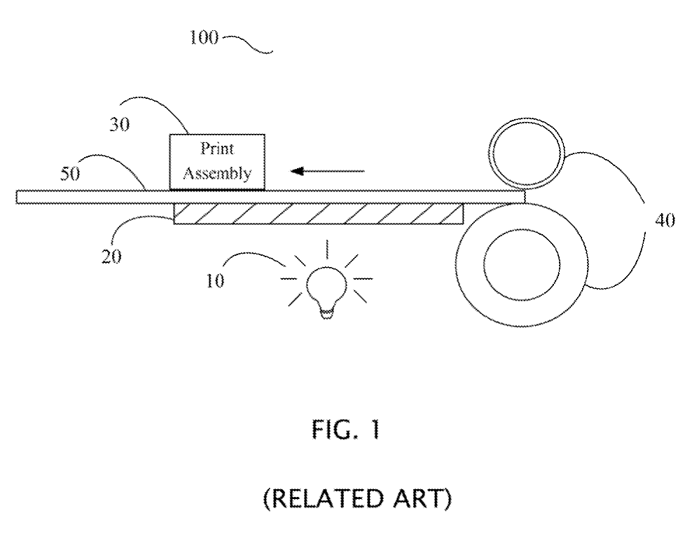

Different from FIG. 1, the printer 200 of FIG. 2 further includes a silicone rubber heater 210 and a support substrate 220.

The silicone rubber heater 210 is in form of thin sheet and attached tightly to the bottom surface of a heat substrate 120 for transferring heat to a print media 150. A standard thickness of the silicone rubber heater 210 may be 0.8 mm, 1.2 mm, 1.5 mm, or any other suitable thickness. The silicone rubber heater 210 may be attached to the bottom surface of the heat substrate 120 by pasting or locking. As a flexible material, the silicone rubber heater 210 is easy to be attached to the heat substrate 120, thereby, less space is used.

The support substrate 220 is set into two parts, separately installed on two sides of the heat substrate 120 and below a print assembly 130, for supporting the print media 150. The support substrate 220 is connected with the silicone rubber heater 210 and two ends of the heat substrate 120. The heat substrate 120 supports and dries the print media 150 by the support substrate 220.

When transmitted between the print assembly 130 and the support substrate 220, the print media 150 is dried by the silicone rubber heater 210 after the ink is sprayed. As heat generated by the silicone rubber heater 210 is transferred to the heat substrate 120, the print media 150 is dried, heat loss is decreased, and the print media 150 absorbs uniform heat.

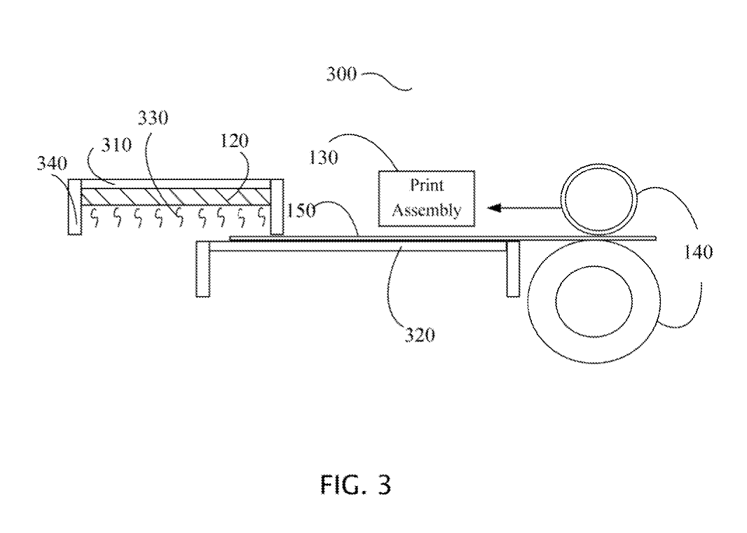

FIG. 3 is a sectional view schematically showing a printer employing an ink drying apparatus according to a second embodiment of the present disclosure.

Different from FIG. 2, the printer 300 of FIG. 3 further includes a support 340. The silicone rubber heater 310 is made into pieces of thin sheets, and is attached tightly to top surface of the heat substrate 120 for transferring heat to the print media 150. The silicone rubber heater 310 and the heat substrate 120 are installed above the support substrate 320 and on printing side of the print assembly 130 by the support 340. A gap 330 is formed between the support substrate 320 and the heat substrate 120 for transferring the print media 150. The gap 330 is also set on the printing side of the print assembly 130.

After the print media 150 is transmitted between the print assembly 130 and the support substrate 220 and the ink is sprayed, the silicone rubber heater 310 starts, heat is transferred to the gap 330, the print media 150 is dried, heat loss is decreased, and the print media 150 absorbs uniform heat.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A printer comprising:
a support substrate comprising two parts;
a print assembly;
a feed roller assembly to feed print media towards the print assembly along the support substrate;
a heater substrate; and
a silicone rubber heater, in form of thin sheet and attached tightly to a bottom surface of the heat substrate for transferring heat to the print media,
wherein the two parts of the support substrate are respectively installed on two sides of the heat substrate and below the print assembly, for supporting the print media;
and wherein the heat substrate and the silicone rubber heater are set below the print assembly.

2. The printer as claimed in claim 1, wherein standard thickness of the silicone rubber heater is 0.8 mm, 1.2 mm, or 1.5 mm.

3. The printer as claimed in claim 1, wherein the silicone rubber heater is attached to bottom surface of the heat substrate by pasting or locking.

4. A printer comprising:
a print assembly;
a support substrate, installed below the print assembly, for supporting a print media;
a feed roller assembly, to feed the print media towards the print assembly along the support substrate;
a heat substrate;
a silicone rubber heater, in form of thin sheet and attached tightly to top surface of the heat substrate, for transferring heat to the print media; and
an support;
wherein the silicone rubber heater and the heat substrate are installed above the support substrate and on a printing side of the print assembly by the support; and
a gap is formed between the support substrate and the heat substrate for transferring the print media, and is also set on the printing side of the print assembly.

5. The printer as claimed in claim 4, wherein standard thickness of the silicone rubber heater is 0.8 mm, 1.2 mm, or 1.5 mm.

6. The printer as claimed in claim 4, wherein the silicone rubber heater is attached to bottom surface of the heat substrate by pasting or locking.
